(19) United States
(12) Patent Application Publication
(10) Pub. No.: US 2015/0085825 A1
(43) Pub. Date: Mar. 26, 2015

(54) COMMUNICATION APPARATUS AND CONTROL METHOD

(71) Applicant: Kabushiki Kaisha Toshiba, Minato-ku (JP)

(72) Inventors: Takeshi ISHIHARA, Yokohama (JP); Kotaro ISE, Kawasaki (JP)

(73) Assignee: Kabushiki Kaisha Toshiba, Minato-ku (JP)

(21) Appl. No.: 14/463,089

(22) Filed: Aug. 19, 2014

(30) Foreign Application Priority Data
Sep. 20, 2013 (JP) 2013-196157

(51) Int. Cl. H04W 36/00; H04W 52/02; H04W 76/06

(52) U.S. Cl. CPC H04W 36/0066; H04W 76/06; H04W 52/0212; H04W 88/06
USPC 370/331

(57) ABSTRACT

According to an embodiment, a communication apparatus includes a first wireless communicator, a storage, and a controller. The first wireless communicator establishes a wireless connection to a network. The storage stores therein data. The controller causes the first wireless communicator to establish a connection to the network when a determination value satisfies a connection condition. The determination value is characterized by at least one of operating conditions, positional information, communication conditions, and communication quality of the communication apparatus. The controller causes the first wireless communicator to obtain information through the network and store the information in the storage or further transmit the information stored in the storage through the network when the determination value satisfies an obtaining condition. The controller disconnects the connection between the first wireless communicator and the network when the determination value satisfies a disconnection condition.

### CROSS-REFERENCE TO RELATED APPLICATION(S)

This application is based upon and claims the benefit of priority from Japanese Patent Application No. 2013-196157, filed on Sep. 20, 2013; the entire contents of which are incorporated herein by reference.

### FIELD

Embodiments described herein relate generally to a communication apparatus and a control method.

### BACKGROUND

Scarcity of the frequency band of a wireless wide area network has become problematic. Thus, off-load traffic to a wireless LAN where high-speed communication can be performed targeting for small areas is sought. However, there are problems such as not being able to smoothly perform communication through a wireless LAN, and increasing power consumption by the use of a wireless LAN. Hence, users continue to download high-volume information using a wireless wide area network.

In addition, services where high-volume information (moving images, etc.) is downloaded through a network and users view the information have become popular. Since it takes time to download such high-volume information, there is a technique for downloading in advance information that suits user's preferences. In addition, as a storage apparatus having a communication function, an SD card in which a wireless LAN and a NAND flash memory are contained in one package is proliferated. By inserting the card into a digital camera, digital images saved in the card can be automatically uploaded to a photo sharing website. In addition, the card is preset to establish a connection to a public wireless LAN. Thus, a user can use wireless LAN communication without performing complex settings.

However, normally, a chip having a wireless LAN function such as that described above increases in its power consumption when operating at all times. Hence, there is demand for a control method that can efficiently connect to and disconnect from a network while suppressing power consumption.

### BRIEF DESCRIPTION OF THE DRAWINGS

FIG. 1 is a block diagram illustrating the functional configuration and hardware configuration of a communication apparatus of an embodiment;

FIG. 2 is a flowchart illustrating the flow of the process of establishing a connection and obtaining information by the communication apparatus of the embodiment;

FIG. 3 is a sequence diagram of a process related to sharing of network information between wireless communicators, in the communication apparatus of the embodiment;

FIG. 4 is a sequence diagram of a process related to sharing of network information between the wireless communicators, in the communication apparatus of the embodiment;

FIG. 5 is a flowchart illustrating the flow of the process of establishing a connection and obtaining information by a communication apparatus of a second embodiment;

FIG. 6 is a flowchart illustrating the flow of the process of establishing a connection and obtaining information by the communication apparatus of the second embodiment;

FIG. 7 is a block diagram illustrating the functional configuration and hardware configuration of a communication apparatus of a modification of the embodiment;

FIG. 8 is a sequence diagram of a process performed between communicators to resume obtaining of information obtained by the communication apparatus of the modification of the embodiment;

FIGS. 9A to 9C are sequence diagrams of the process of obtaining information in a storage of the communication apparatus from a processor, in the communication apparatus of the modification of the embodiment; and

FIG. 10 is a sequence diagram of the process of obtaining information in the storage of the communication apparatus from the processor, in the communication apparatus of the modification of the embodiment.

### DETAILED DESCRIPTION

According to an embodiment, a communication apparatus includes a first wireless communicator, a storage, and a controller. The first wireless communicator establishes a wireless connection to a network. The storage stores therein data. The controller causes the first wireless communicator to establish a connection to the network when a determination value satisfies a connection condition. The determination value is characterized by at least one of operating conditions, positional information, communication conditions, and communication quality of the communication apparatus. The controller causes the first wireless communicator to obtain information through the network and store the information in the storage or further transmit the information stored in the storage through the network when the determination value satisfies an obtaining condition. The controller disconnects the connection between the first wireless communicator and the network when the determination value satisfies a disconnection condition.

### First Embodiment

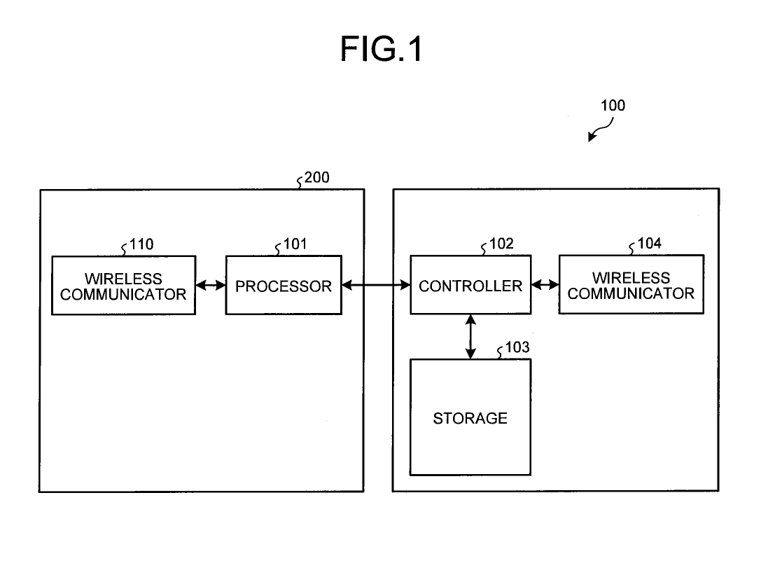

A first embodiment in which a communication apparatus of the present invention is embodied will be described below with reference to the drawings. FIG. 1 is a block diagram illustrating a state in which a communication apparatus 100 and an external apparatus 200 are connected to each other, and illustrating the functional configurations of the communication apparatus 100 and the external apparatus 200. The communication apparatus 100 is assumed to be hardware having a wireless communication function, e.g., a card-type wireless LAN card, a wireless connection module for smartphones, or a chipset. The external apparatus 200 includes a processor 101 and a wireless communicator 110. The communication apparatus 100 includes a controller 102, a storage 103, and a wireless communicator 104. Since the communication apparatus 100 operates independently of the processor 101 of the external apparatus 200, processes required for communication such as a TCP/IP stack and a network application are also performed by the controller 102. The storage 103 is a storage composed of, for example, a NAND flash memory, and saves information obtained through the wireless communicator 104, etc. The wireless communicator 104 implements wireless communication compliant with, for example, IEEE 802.11n. Note that, though not illustrated in the configuration of FIG. 1, a communication interface may be provided in addition to the wireless communicator 104. Likewise, a storage other than the storage 103 may be provided.

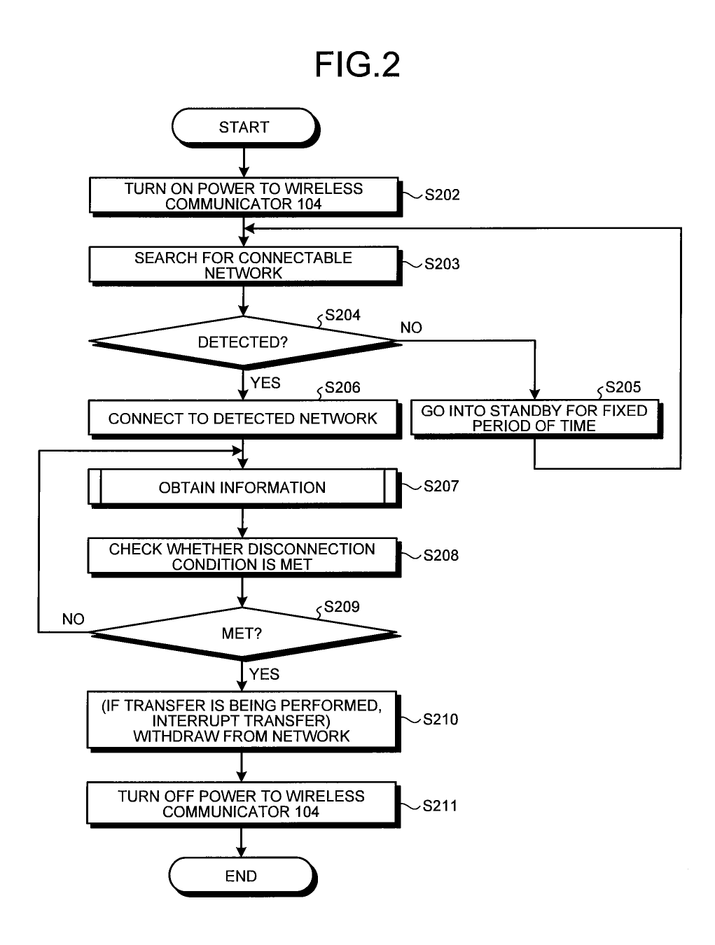

FIG. 2 illustrates the flow of the operation of the communication apparatus 100 performed by the controller 102. When a process starts by receiving an instruction from the processor 101, the controller 102 turns on the power to the wireless communicator 104 (step S202). At this time, when the wireless communicator 104 is not in a power-off state, but is just transitioned to a low power consumption state (so-called sleep state), the controller 102 performs the process of allowing the wireless communicator 104 to return to a normal operating state, instead of performing a power operation. In addition, when the controller 102 can perform a power operation by itself, the controller 102 performs the power operation, but if a process by the processor 101 is required, the controller 102 requests the processor 101 for power-on, and the processor 101 performs a power operation.

When the wireless communicator 104 starts operating, a search for a connectable network starts (step S203). This is performed by receiving a beacon frame which is transmitted by a neighboring wireless LAN access point. The controller 102 determines whether a connectable network has been detected (step S204). If a connectable network has been detected (S204: YES), the controller 102 establishes a connection to the target network through the wireless communicator 104 (step S206). This is done by performing a series of processes defined in IEEE 802.11. Note that information required for the connection (SSID, user name, password, etc.) may be already preset, or a user may be required to input such information through some kind of interface, or such information may be obtained from an external device by some kind of means.

On the other hand, if a connectable network has not been found (S204: No), the controller 102 goes into standby for a fixed period of time (step S205), and then performs a search again through the wireless communicator 104. At this time, if the number of times the controller 102 has failed to find a connectable network reaches a predetermined number of times, the controller 102 may stop a search and transition to step S211 to turn off the power.

When the controller 102 has been able to establish a connection to the network, the controller 102 starts obtaining of desired information from a connected server, etc., through the network (step S207). A communication protocol used at this time is, for example, HTTP (in the caser of a web page, etc.) or IMAP (in the case of electronic mail). It is assumed that information (e.g., a URI) that identifies information to be obtained is notified to the controller 102 in advance or is saved in the storage 103. The number of pieces of such information is not limited to one and may be plural.

During obtaining of information, the controller 102 stores in the storage 103 desired information among information received by the wireless communicator 104, and checks whether a wireless communication disconnection condition is met (step S208). The check process is performed, for example, every fixed period of time. If the disconnection condition is met (S209: YES), when information is being transferred, the controller 102 interrupts the transfer and withdraws from the network (step S210). Note that, when information is not being transferred, the controller 102 simply withdraws from the network. Thereafter, the controller 102 turns off the power to the wireless communicator 104 (step S211) and ends the process. Note that, when the wireless communicator 104 supports a low power consumption state, the controller 102 may allow the wireless communicator 104 to transition to a sleep state, instead of turning off the power. When the controller 102 can perform a power-off process by itself, the controller 102 performs the power-off process. When the power-off process requires control by the processor 101, the controller 102 requests the processor 101 for power-off, and the processor 101 controls the power to the wireless communicator 104. Note that at this time the controller 102 may request the wireless communicator 110 to search for a network. By doing so, even if the wireless communicator 104 is in an off state or a low power consumption state, by the wireless communicator 110 searching for a network instead and sharing network information having been found, the wireless communicator 104 can promptly return to a network-connected state when placed in a power-on state.

In the above-described process, when the power is turned on, a connection to a network is automatically established and downloading of predetermined data starts, and thus, a wireless connection can be easily established. In addition, when a disconnection condition such as completion of downloading of information has been met, the power to the wireless communicator 104 is turned off, and thus, power more than necessary is not consumed.

For the disconnection condition at step S208, a condition for normal time and a condition for abnormal time are considered. The condition for normal time is that “all processes to be performed have been completed”. The condition for abnormal time is considered to be, for example, operating information such as “a beacon from an access point has not been able to be received”, “the remaining battery level falls below a threshold value”, or “the number of terminals connected to an access point exceeds a preset threshold value”, communication conditions such as “the strength of a radio wave received falls below a threshold value”, “the throughput for obtaining information falls below a threshold value”, “the packet loss rate exceeds a threshold value”, or “the frame error rate exceeds a threshold value”, or positional information such as “the apparatus has moved (movement has been detected by an acceleration sensor or the like, which is not illustrated, or a value obtained from the GPS has changed)” or “the apparatus has moved away from an access point (the distance from an access point which is determined by some kind of positioning technique is greater than a preset threshold value)”. Note that these disconnection conditions may be saved in the storage 103 or may be stored in another storage which is not illustrated. In addition, since a determination result is expected to change over time, a determination process may be repeatedly performed taking into consideration the degree of importance of information to be obtained, the remaining battery level, etc. Namely, these disconnection conditions and connection conditions are set depending on whether a determination value characterized by at least one of operating conditions, positional information, communication conditions, and communication quality satisfies a predetermined condition.

It has been described that at step S210, if communication is being performed when the disconnection condition has been met, the communication is interrupted and then the controller 102 withdraws from the network. At this time, the communication may be simply interrupted; however, in that case, obtained information cannot be utilized later. Hence, information required to resume obtaining of information may be saved as resume information upon interruption; and when the power is turned on again, resumption may be performed using the resume information. The information saved upon interruption includes the identifier of information being obtained and the size of obtained information. The information may be saved in the storage 103, or may be passed to the processor 101 and saved in another storage (not illustrated) managed by the processor 101, or may be saved in both of the storages. When the information is saved in the storage of the processor 101, by the processor 101 notifying of the saved information together with a power-on instruction, the controller 102 can resume obtaining of information.

Note that when the disconnection condition in the controller 102 is a condition for normal time (e.g., completion of obtaining of information), simply only disconnection from the network and power control are performed without generating resume information.

Next, cooperation between the wireless communicator 110 and the wireless communicator 104 will be described. The wireless communicator 110 is, unlike the wireless communicator 104 controlled by the controller 102, a wireless communication interface controlled by the processor 101. It is assumed that the communication scheme is compatible with the wireless communicator 104. An example thereof includes a wireless communication interface compliant with IEEE 802.11n. Note that, as a communication scheme different than that of the wireless communicator 104, LTE, etc., may be adopted. Note that in the following description, “active” indicates an operating state with the power turned on, and “inactive” indicates a power-off state. Note also that “sleep state” indicates a low-power state with the power turned on.

First, the case is assumed in which the wireless communicator 104 is active and the wireless communicator 110 is also active. When both of the wireless communicator 104 and the wireless communicator 110 are active, the wireless communicators basically operate independently of each other. The explanation of the controller 102, the storage 103, and the wireless communicator 104 is the same as the above-described explanation. Note that the wireless communicator 104 and the wireless communicator 110 may operate in cooperation with each other and, for example, one of the interfaces may intensively perform a network search, etc.

Next, the case is assumed in which the wireless communicator 104 is active and the wireless communicator 110 is inactive. When the wireless communicator 104 is active and the wireless communicator 110 is inactive, the controller 102 searches for a connectable network, using the wireless communicator 104.

Next, the case is assumed in which the wireless communicator 104 is inactive and the wireless communicator 110 is active. When the wireless communicator 104 is inactive and the wireless communicator 110 is active, the controller 102 searches for a network to which the wireless communicator 104 can establish a connection, using information obtained from the processor 101.

The processor 101 can know a neighboring wireless LAN access point through the wireless communicator 110. When the wireless communicator 104 is inactive, the controller 102 requests the processor 101 to share information collected through the wireless communicator 110. In response to the request, the processor 101 shares the collected information with the controller 102. The controller 102 can resume operation by two methods. The first method is detecting whether there is a connectable network, by directly referring to the shared information. The second method is that the processor 101 detects a network to which the controller 102 can establish a connection and which is shared in advance, and notifies the controller 102 of the network using an interrupt signal, etc. Note that when a plurality of candidates is shared as connectable networks, a connection destination may not be able to be identified only by an interrupt signal. In that case, a connection destination is notified using a storage, another signal line, etc.

By the above-described operation, two wireless communicators do not operate only to detect a connectable network. Thus, a connectable network can be detected with an increase in power consumption suppressed.

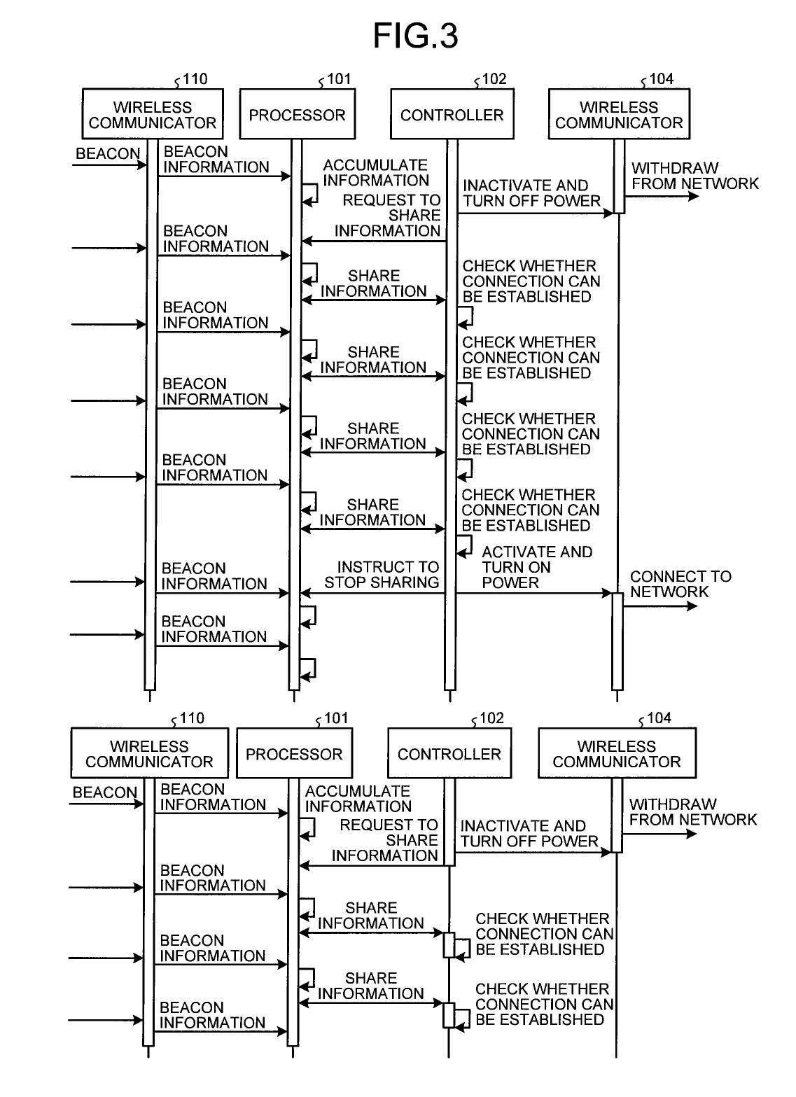

The flow of the above-described operation of sharing information between the wireless communicators will be described using FIG. 3. FIG. 3 illustrates three phases, i.e., a state in which the wireless communicator 104 is in operation, a state in which the wireless communicator 110 searches for a connectable network using shared information, and a state in which a connectable network has been found and thus the wireless communicator 104 has become active again. In an intermediate state in which a search is performed, the wireless communicator 110 is not operating (a thick portion indicates “on” and a thin portion indicates “off”). In the drawing, every time information is shared, it is checked whether a connection can be established; however, the check does not necessarily need to be performed every time and may be performed intermittently. At that time, the controller 102 may transition to a low power consumption state between check processes.

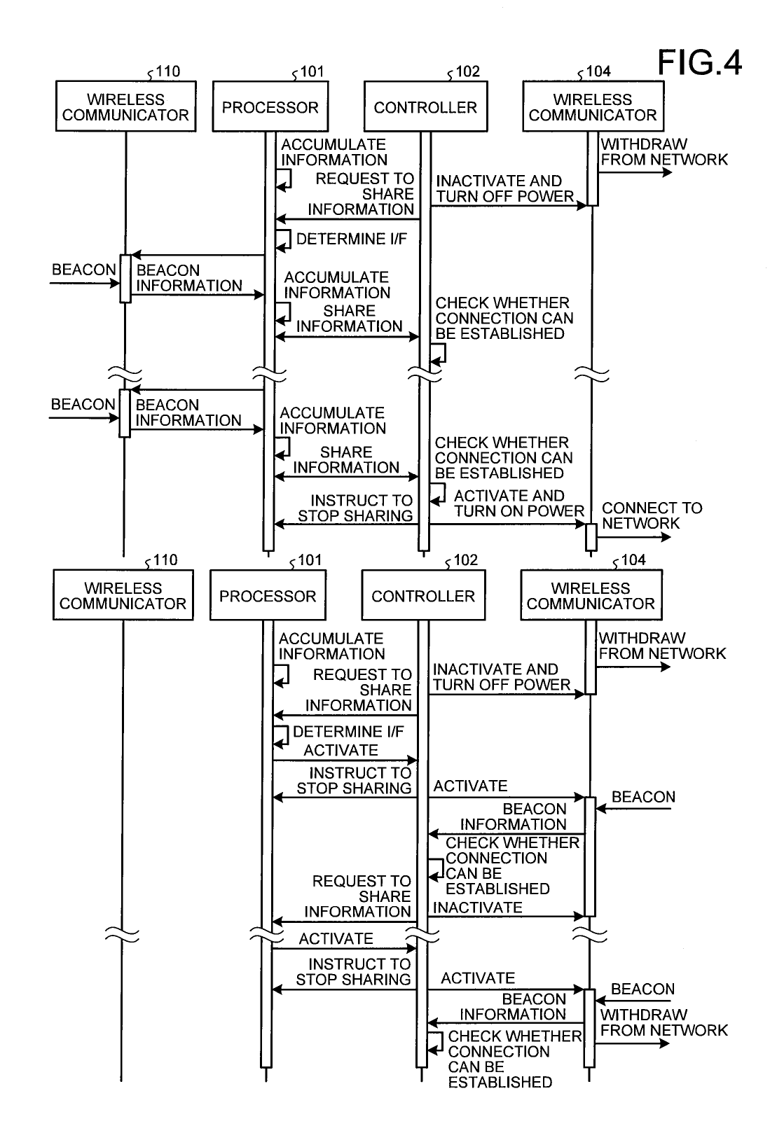

Finally, when both of the wireless communicator 104 and the wireless communicator 110 are inactive, either one of the wireless communicators periodically becomes active, and detects a network to which the wireless communicator 104 can establish a connection. At this time, a wireless communicator to be used is determined by the processor 101. When the wireless communicator 104 is inactive, as described above, the processor 101 receives a request from the controller 102 to share information. When, under such circumstances, the wireless communicator 110 is inactive, the processor 101 causes one of the wireless communicators to be active periodically. When the wireless communicator 104 is caused to be active, the above-described process for when the wireless communicator 104 is active is performed. Note that, when a connectable network has not been found, the wireless communicator 104 stops its operation, going into an inactive state. In addition, at the time point when the wireless communicator 104 is caused to be active, a request to cancel the sharing of information is transmitted to the processor 101. Likewise, at the time point when the wireless communicator 104 is caused to be inactive, a request to share information is issued again. When the wireless communicator 110 is caused to be active, operation is performed by the method for when only the wireless communicator 110 is active. After going into a state where collected information can be shared, the wireless communicator 110 goes into an inactive state again. A series of operations are as illustrated in FIG. 4.

Information to be shared through the processor 101 when the wireless communicator 104 is inactive and the wireless communicator 110 is active is, for example, as follows:

MAC address: a MAC address that identifies an access point

SSID: an identifier that identifies a wireless network provided by the access point

Channel: a channel used by the access point

Speed information: communication speed supported by the access point

Security information: an authentication/encryption scheme used when connecting to the access point

RSSI: strength of a signal received from the access point

In addition to such a method in which specific information is thus shared by interpreting a received beacon frame, a beacon frame received by the wireless communicator 110 may be shared as it is. In addition, to connect to an operating access point without including an SSID in a beacon, the SSID of an access point desired to be connected may be included in an information sharing request. At that time, the processor 101 actively checks whether there is an access point having the specified SSID, and shares the result of the check with the controller 102.

By thus sharing obtained information between the wireless communicators, the operation of the wireless communicator 104 can be resumed while suppressing power consumption.

### Second Embodiment

In the first embodiment, when a wireless communicator 104 detects a connectable network, the wireless communicator 104 establishes a connection to the network, and when the wireless communicator 104 establishes a connection to the network, the wireless communicator 104 immediately obtains preset information. On the other hand, in the present embodiment, a connection is established only when a predetermined condition is satisfied. In addition, even if a connection is being established, only when a predetermined condition is satisfied, obtaining of information starts.

In the present embodiment, in a processor 101, a control application operates that has the function of minutely controlling the conditions for a connection and obtaining of information, in addition to the function of controlling the overall operation of the apparatus. A storage 103 saves various conditions for controlling the execution timing of a connection and obtaining of information. In addition, the storage 103 may have the function as a temporary storage (working memory) of a controller 102. The controller 102 has, in addition to the functions described in the first embodiment, the function of controlling the timing of a connection to a network by a wireless communicator 104 and the timing of obtaining of information using the wireless communicator 104, according to an instruction from the control application operating in the processor 101 and the conditions saved in the storage 103.

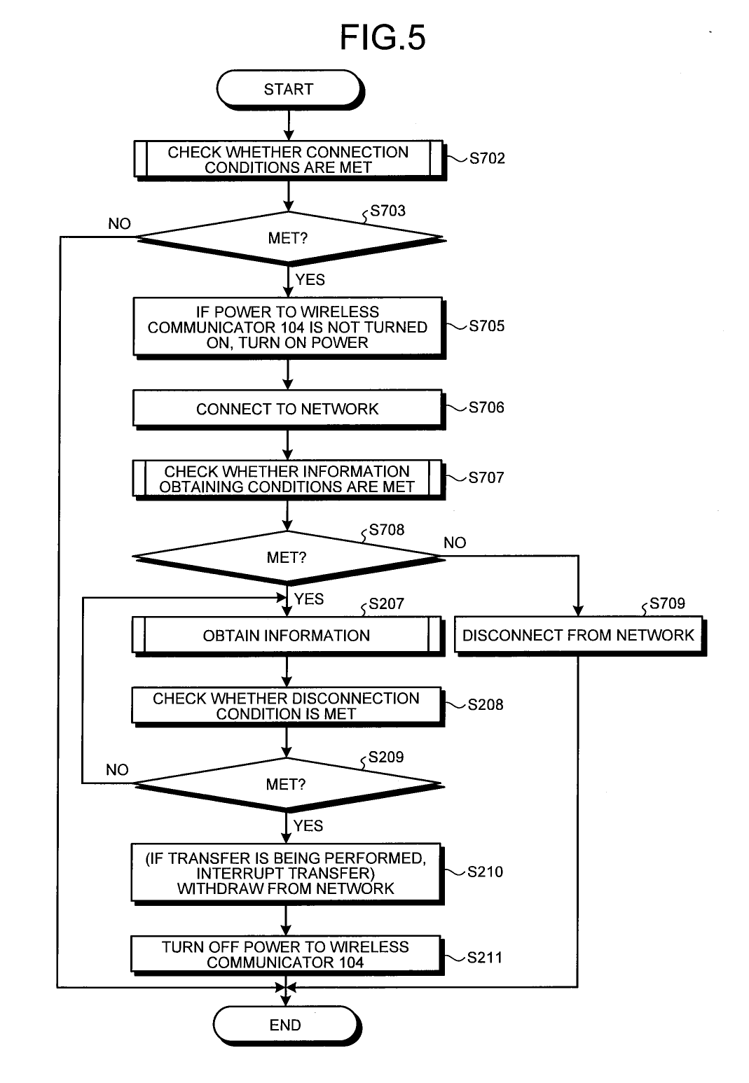

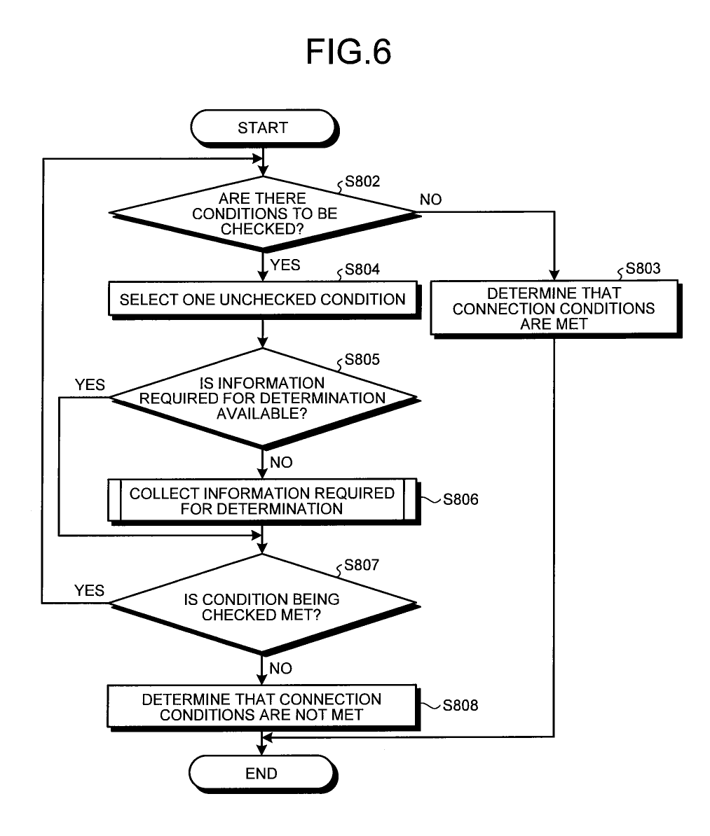

FIG. 5 is a flowchart of the operation of the controller 102 in the present embodiment. A determination about a connection to a network and processes related thereto (S702 to S706) and a determination about obtaining of information and processes related thereto (S707 to S709) are added to the flowchart in the first embodiment which is illustrated in FIG. 2. A flowchart of a determination about connection conditions and obtaining conditions is illustrated in FIG. 6. In FIG. 5, it is assumed that one or more conditions are stored in the storage 103. In addition, it is assumed that an instruction from the processor 101 is also stored in the storage 103. Note that these pieces of various information may be stored in a storage different than the storage 103.

First, the controller 102 determines whether the connection conditions are met (step S702). If the connection conditions are met (step S703: Yes), the controller 102 determines whether the power to the wireless communicator 104 is turned on. If not turned on, the controller 102 turns on the power (step S705). Then, the controller 102 establishes a connection to a network through the wireless communicator 104 (step S706). When a connection is established to the network, the controller 102 checks whether the information obtaining conditions have been met (step S707). If the information obtaining conditions have been met (step S708: Yes), the controller 102 performs the above-described processes at and after step S207. If the information obtaining conditions are not met (step S708: No), the controller 102 disconnects from the network (step S709) and ends the process.

As described previously, an instruction from the processor 101 is obtained by various methods. For example, it is possible to use a method in which an instruction is obtained by accessing a register of the processor 101 where the content of the instruction is stored, and a method in which an instruction is obtained as a signal on a signal line provided between the processor 101 and the controller 102. In addition, in the flowchart of FIG. 6, when all conditions stored in the storage 103 are satisfied, it is determined to be “met”; however, when, for example, a logical OR between conditions is formed, all conditions do not necessarily need to be determined.

Next, the process of determining whether the connection conditions have been met will be described. As illustrated in FIG. 6, the controller 102 first determines whether unchecked connection conditions to be checked remain in the storage 103 (step S802). If connection conditions remain (step S802: Yes), the controller 102 selects one of the unchecked connection conditions (step S804). Then, the controller 102 checks, for the selected connection condition, whether information required for the determination is available (step S805). This is to check whether, when information on a sensor, etc., is required for the condition determination, those pieces of information have been able to be appropriately obtained. For example, when the connection condition includes positional information, it is checked whether positional information with appropriate accuracy has been able to be obtained, and when the connection condition includes a movement condition, it is checked whether the value of an acceleration sensor has been able to be obtained. Note that items that are continuously measured substantially routinely in the wireless communicator 104, such as an RSSI value from an expected connection destination and remaining battery level, are determined at this step to be available.

If it is determined that information is not sufficiently available for the connection condition determination (step S805: No), the controller 102 collects information required for the determination (step S806). As described previously, the information may be obtained using various types of sensors. Note that the case of requiring a connection to a wide area network which is not illustrated is also considered depending on the type of information (e.g., base station information of a wide area network).

Then, the controller 102 determines whether the connection condition has been met (step S807). If it is determined that the connection condition has been met (step S807: Yes), the controller 102 returns to step S802 to make a determination about the next connection condition. On the other hand, if it is determined that the connection condition is not met (step S807: No), the controller 102 determines that the connection conditions are not met, and thus, ends the process (step S808).

Then, when all connection conditions are determined to be met and thus there is no more unchecked connection condition (step S802: No), finally, the controller 102 determines that the connection conditions have been met (step S803), and thus, performs the process of establishing a connection to a network. Note that although the above shows the process related to the connection condition determination, the same processing procedure can also be used for the obtaining conditions by replacing the connection conditions with the obtaining conditions. Note, however, that the number of pieces of information required for the determination increases compared to the case of the connection determination. For example, the information is considered to be throughput and delay between the apparatus and an assumed communication counterpart, communication time estimated from the throughput, current time, current position, movement conditions, the degree of congestion at a connected wireless LAN access point, SSID, an IP address identifying a connected network, an IP address of the communication counterpart, remaining battery level, and an URL (domain) to be obtained. To obtain these pieces of information, at step S806, a necessary process is performed. For example, when throughput and delay are required, a connection is established to a communication counterpart, and the throughput and delay thereof are measured. For the degree of congestion at a wireless LAN access point, for example, there are considered a method in which the degree of congestion is directly obtained from the access point, and a method in which the degree of congestion is obtained by inquiring a management server of a telecommunications carrier. Note that assuming, for example, the case in which it is difficult to establish a connection to the actual communication counterpart, measurement may be performed with a server that is prepared in advance. For other information, too, likewise, in the case of obtaining the current time, synchronization is achieved with a time server, and in the case of obtaining the current position, the position is measured using the GPS, etc.

A measurement method is not limited to one type, and a plurality of measurements may be continuously performed, or a plurality of measurements may be simultaneously performed. Alternatively, necessary information may be listed in advance, and after obtaining those pieces of information at a time, a determination may be performed. Furthermore, in FIG. 6, these pieces of information are collected as part of the connection determination and the information obtaining determination, but may be collected independently. Furthermore, a series of information may be collected by proxy by a management server that manages a wireless LAN network or a wireless wide area network, etc., and the apparatus may obtain the series of information.

The controller 102 performs a series of determination processes such as those described above, and the processor 101 may control the conditions for the processes. For example, an application that adds or deletes a determination condition, temporarily invalidates a condition, and checks or overwrites a determination result may be operated.

(Modification)

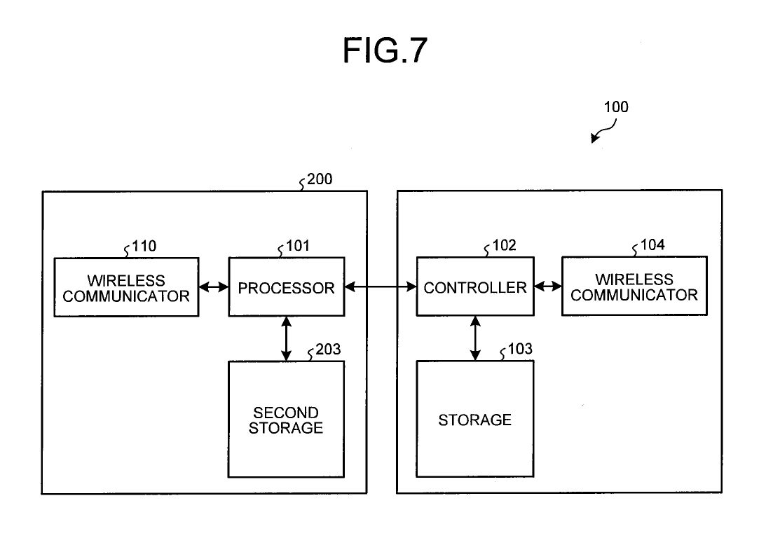

Next, a modification for the case will be described in which, when interruption occurs in the middle of obtaining information by a communication apparatus 100, a wireless communicator 110 resumes obtaining of information using resume information. Although in the first embodiment resume information is stored in a storage 103 of a communication apparatus 100, the resume information also needs to be stored in a second storage 203 of an external apparatus 200 illustrated in FIG. 7. Specifically, a processor 101 continues obtaining of information, based on resume information notified from a controller 102. The controller 102 interrupts obtaining of information being performed, organizes the obtaining conditions in resume information, and shares the resume information with the processor 101. Then, the processor 101 stores the resume information, etc., in the second storage 203.

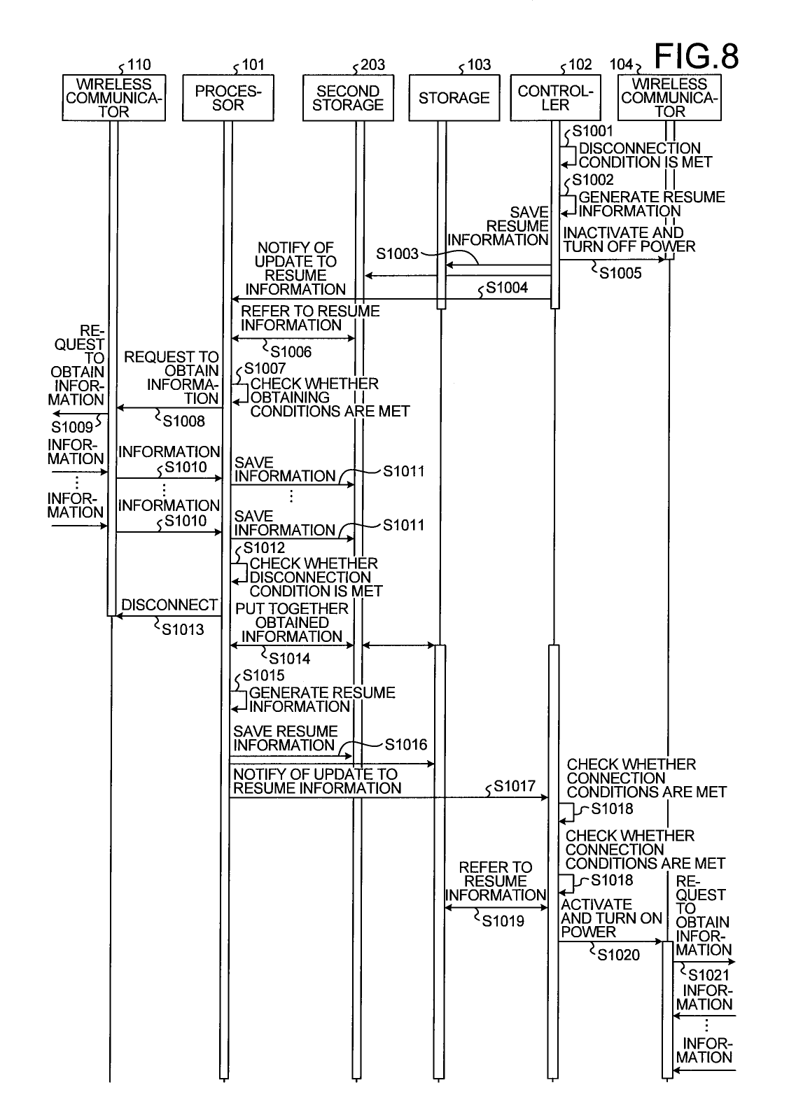

FIG. 8 illustrates an operation sequence of an example case in which obtaining of information by a wireless communicator 104 is interrupted, and a wireless communicator 110 takes over obtaining of information, and then again, the wireless communicator 104 resumes obtaining. A thick-frame portion in FIG. 8 indicates “being operated” and a thin-line portion indicates “being stopped” or “power-saving state”.

If the controller 102 determines that obtaining of information through the wireless communicator 104 is not in an appropriate state (step S1001), the controller 102 performs a disconnection process and generates resume information (step S1002). The generated resume information is saved in a storage 103 (step S1003) and is shared with the processor 101 and is also saved in the second storage 203 (step S1004). After sharing the information, the controller 102 may perform control to reduce the power consumption of the entire apparatus by turning off the power to the controller 102 and the wireless communicator 104 (step S1005).

The processor 101 checks the updated resume information (step S1006) and checks whether an obtaining condition for information to be obtained is met (step S1007). If not met, the processor 101 does not perform obtaining using the wireless communicator 110. The processor 101 goes into standby or transitions to a low power consumption state. Note, however, that as described above, a search for a connectable wireless LAN access point, etc., may be performed.

If the connection condition has been met, the processor 101 requests the wireless communicator 110 to obtain information (step S1018), and the wireless communicator 110 establishes a connection to a communication counterpart to obtain information (step S1009). The processor 101 stores the obtained information in the second storage 203 (steps S1010 and S1011). In the sequence of FIG. 8, the obtained information is temporarily saved in the second storage 203, and when a disconnection process is performed (steps S1012 and S1013), the controller 101 puts together and organizes the obtained information and writes the information in the second storage 203. On the other hand, the information may be directly saved in the storage 103 (in that case, since the information is saved through the controller 102, the controller 102 needs to be appropriately in operation).

When a disconnection condition is met in the processor 101, the processor 101 generates resume information (steps S1014 and S1015), and the resume information is saved in the second storage 203 and the storage 103, and is thereby shared with the controller 102 (step S1016). Note that, when the power to the controller 102 and the storage 103 is turned off upon sharing, the power is turned on in advance. The processor 101 notifies the controller 102 that the resume information has been updated (step S1017). When the controller 102 confirms the update to the resume information (step S1018), the controller 102 refers to the resume information (step S1019) and activates the wireless communicator 104 (step S1020) to resume an information obtaining process (step S1021).

In the case of the above-described modification, pieces of information obtained by different wireless communicators are put together and shared as resume information. By this, communication can be performed using a plurality of wireless communicators without a user being aware of it.

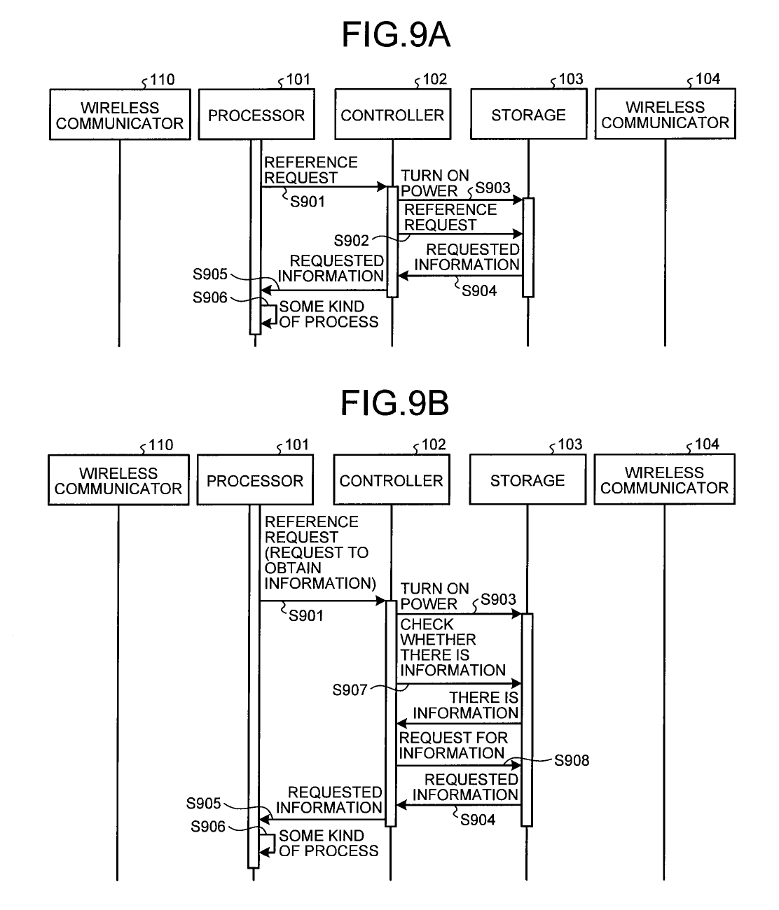

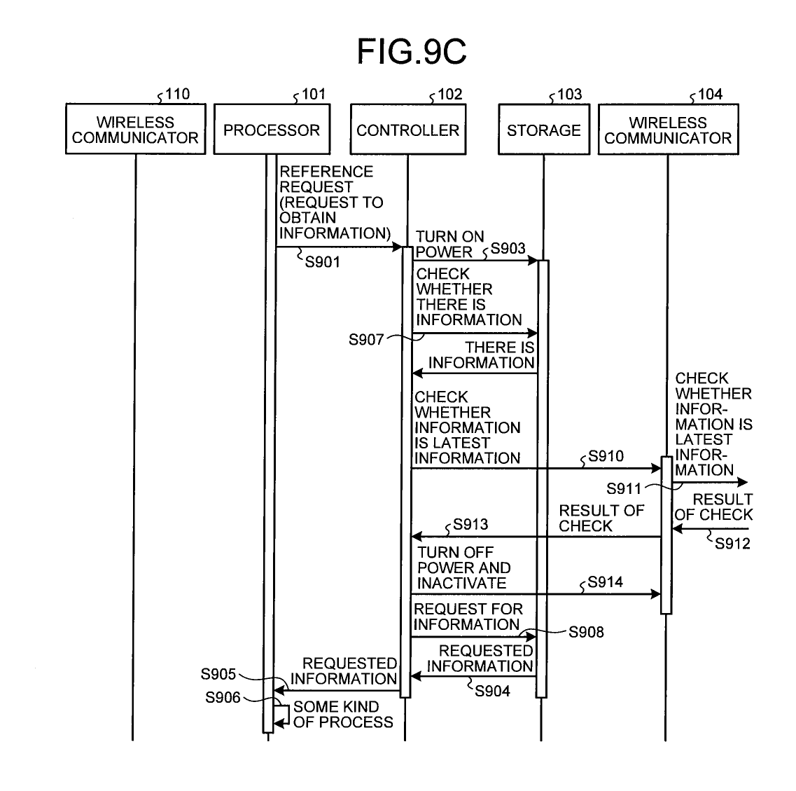

In addition, instead of the process of obtaining information, the flow of a process for the case of using obtained information between the external apparatus 200 and the communication apparatus 100 will be described. FIGS. 9A to 9C illustrate the operation sequences of each component. In the drawing, a process starts assuming that information is stored in the storage 103 and the processor 101 uses the information.

FIG. 9A illustrates the case in which simply the processor 101 refers to information in the storage 103. When the processor 101 issues a reference request (step S901), the controller 102 interprets the reference request and sends to the storage 103 a request to refer to desired information (step S902). At that time, if the controller 102 has transitioned to a sleep state or the power to the storage 103 is turned off, the controller 102 recovers by a signal from the processor 101, or a current is allowed to pass through the storage 103 by the controller 102 upon referring (step S903). The controller 102 reads from the storage 103 information for which the reference request is issued (step S904) and passes the information to the processor 101 (step S905). Then, the processor 101 performs some kind of process (step S906). As a result, the information may be presented to a user of the apparatus or may be stored again in the storage 103, etc.

Note that the reference request can be implemented in various forms. For example, it is assumed that the controller 102 performs control such that the storage 103 can be referred to by the processor 101, as some kind of file system. In that case, the reference request is a file access request, and information serving as a response is returned as the content of a file. In addition, for example, the reference request may be an information obtaining request from the processor 101 to the controller 102 which is described in other embodiments. In this case, information is obtained through the wireless communicator 104 in the above-described embodiments. However, in FIG. 9B, it can be checked by processes at steps S907 and S908 that target information is saved in the storage 103, and thus, the operation of returning the target information to the processor 101 without communicating with an external server through a wireless network is performed.

In addition, as illustrated in FIG. 9C, when the processor 101 issues a request as an information obtaining request, the controller 102 may check whether information is saved in the storage 103 (step S907), and if saved, the controller 102 may check whether the information is the latest information (step S910 to S914). In this case, the case is illustrated in which the result of the check reveals that the latest information is saved in the storage 103. If not saved, the controller 102 obtains the latest information before turning off the power to the wireless communicator 104 and inactivating the wireless communicator 104. The obtaining process is performed in accordance with the previously described methods in the embodiments.

In a series of operations described here, the case is considered in which, when information is obtained from the storage 103, some information has not been able to be obtained. In that case, the process of obtaining unobtained information may be performed according to the previously described embodiments. At that time, the processor 101 may be notified of the fact that information is being obtained. On the other hand, when information has a missing portion, a process may be performed considering that the storage 103 does not have corresponding information.

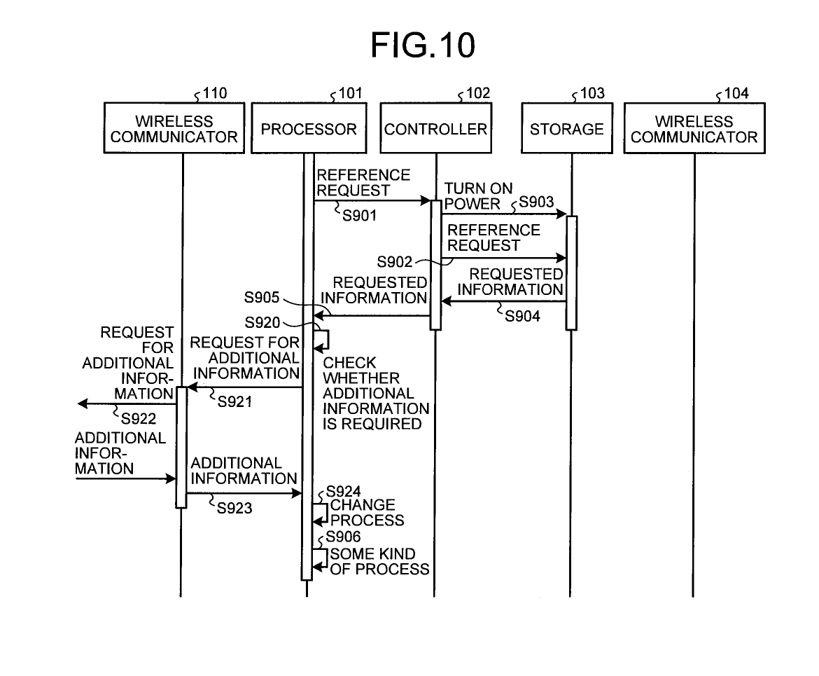

FIG. 10 is a sequence diagram for a modification of the case in which the process of obtaining additional information is added by the wireless communicator 110. For example, there is a possibility that a decryption key required to obtain original information, etc., may be distributed through a different path than that for obtained information. To handle such a case, the processor 101 having obtained information from the storage 103 checks whether additional information is required (step S920). If it is determined that additional information is required, the processor 101 obtains the information using a communication means appropriate for acquiring the information (steps S921 to S923). Note that at step S920 in FIG. 10 it is determined that the information needs to be obtained using the wireless communicator 110, and thus, the wireless communicator 110 is activated to obtain the information. Note that this information for making a determination may be included in the information obtained from the storage 103 or may be programmed in advance. Alternatively, the user may set the information for making a determination as occasion arises.

In addition to a decryption key, examples in which the present modification can be applied are considered to include obtaining of supplemental information to be additionally displayed on an already obtained moving image, and notifying an external server of the current location information of the apparatus by the wireless communicator 110 and checking whether there is information related to the current location information. Furthermore, the step of checking whether the obtained information is the latest information may also be performed by the method described here. Note that how to handle additionally obtained information is not limited here. The information may be saved in the storage 103 and then reused at timing at which the information is referred to next time, or the saved additional information may be provided with a period of validity so as to be reused during a fixed period of time, or the information may be discarded after use and obtained without fail.

The previously described embodiments of the present invention describe the case of obtaining information. However, the present invention can also be applied to the case of transmitting information to a network. At that time, information accumulated in a storage is transmitted to a network, according to a URL specified in advance.

The communication apparatuses 100 of the above-described embodiments have a hardware configuration including, for example, a control apparatus such as a CPU, storage apparatuses such as a ROM (Read Only Memory) and a RAM, and external storage apparatuses such as an HDD and a CD drive apparatus.

Programs executed by the communication apparatuses 100 of the above-described embodiments are provided by being recorded in a computer-readable recording medium, such as a CD-ROM, a flexible disk (FD), a CD-R, or a DVD (Digital Versatile Disk), in an installable or executable format file.

Alternatively, the programs of the above-described embodiments may be configured to be provided by being stored on a computer connected to a network such as the Internet, and downloaded via the network. Alternatively, the programs executed by the communication apparatuses 100 of the above-described embodiments may be configured to be provided or distributed via a network such as the Internet.

Alternatively, the programs of the above-described embodiments may be configured to be provided by being pre-installed in a ROM, etc.

In addition, the programs executed by the communication apparatuses 100 of the above-described embodiments have a module configuration including the above-described units. In the actual hardware, a CPU (processor) reads a program from the storage medium and executes the program, by which the units are loaded onto a main storage apparatus and created on the main storage apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus comprising:
a first wireless communicator to establish a wireless connection to a network;
a storage to store therein data; and
a controller to:
cause the first wireless communicator to establish a connection to the network when a determination value satisfies a connection condition, the determination value being characterized by at least one of operating conditions, positional information, communication conditions, and communication quality of the communication apparatus;
cause the first wireless communicator to obtain information through the network and store the information in the storage or further transmit the information stored in the storage through the network when the determination value satisfies an obtaining condition; and
disconnect the connection between the first wireless communicator and the network when the determination value satisfies a disconnection condition.

2. The apparatus according to claim 1, wherein
when the disconnection condition is satisfied after starting obtaining or transmission of predetermined information through the network, the controller saves resume information in the storage, the resume information indicating a state of the obtained information or the transmitted information at a time of disconnection, and
when a connection is established again to the network, the controller resumes, based on the resume information, obtaining or transmission in the state of the obtained information or the transmitted information at the time of disconnection.

3. The apparatus according to claim 2, wherein
the controller notifies an external apparatus of the resume information, and
when the external apparatus resumes communication and resumes obtaining or transmission of information based on the resume information, the controller receives the obtained or transmitted information from the external apparatus and updates the resume information stored in the storage.

4. The apparatus according to claim 2, wherein, when a connection of the communication apparatus to an external apparatus is disconnected and the communication apparatus is connected to the external apparatus again, the controller resumes obtaining or transmission of information, based on the resume information stored in the storage.

5. The apparatus according to claim 2, wherein
when a connection of the communication apparatus to an external apparatus is disconnected and the communication apparatus is connected to the external apparatus again, the controller accepts reference of the resume information in the storage by the external apparatus, and
when a second wireless communicator included in the external apparatus starts obtaining of information based on the resume information, the controller receives the obtained information from the external apparatus and saves the information in the storage.

6. The apparatus according to claim 1, wherein
the external apparatus includes:
a second wireless communicator; and
a processor to control a connection between the second wireless communicator and the network,
the controller and the processor search for the network to which the second wireless communicator or the first wireless communicator establishes a connection,
when at least one of the second wireless communicator and the controller transitions to a low power consumption state, the controller requests the processor of the external apparatus to search for a network, and
when the processor has detected a connectable network through the second wireless communicator, the controller receives information required to establish a connection to the network from the processor, the information being acquired by the processor.

7. A control method for a communication apparatus including: a first wireless communicator to establish a wireless connection to a network; a storage to store therein data; and a controller, the method comprising:
causing, by the controller, the first wireless communicator to establish a connection to the network when a determination value satisfies a connection condition, the determination value being characterized by at least one of operating conditions, positional information, communication conditions, and communication quality of the communication apparatus;
causing, by the controller, the first wireless communicator to obtain information through the network and store the information in the storage or further transmit the information stored in the storage through the network when the determination value satisfies an obtaining condition; and
disconnecting, by the controller, the connection between the first wireless communicator and the network when the determination value satisfies a disconnection condition.
